(19) United States
(12) Patent Application Publication
(10) Pub. No.: US 2006/0200474 A1
(43) Pub. Date: Sep. 7, 2006

(54) Alternative sourcing assessment

(76) Inventors: Marc E. Snyder, Sudbury, MA (US); Markus Zahn, Frankfurt (DE); Jan D. Stuve, Frankfurt (DE); Holger Fink, Kronberg (DE); Jurgen R. Pinkl, Burgrieden (DE); Jamie R. Moors, Konigstein/Falkenstein (DE)

Correspondence Address: FISH & RICHARDSON P.C., P.O. BOX 1022, MINNEAPOLIS, MN, 55440-1022, US

(21) Appl. No.: 11/071,568

(22) Filed: Mar. 2, 2005

(51) Int. Cl. G06F 17/00

(52) U.S. Cl. 707/100

(57) ABSTRACT

A method and apparatus, including a computer program product, implementing techniques for providing a sourcing model recommendation for business applications. The techniques include grouping a plurality of application programs to form one or more application clusters. One or more of a suitability assessment, readiness assessment, and risk assessment can be performed for each application cluster. The results of the assessments for each application cluster can be used in whole or in part to provide sourcing model recommendations for each of the application clusters.

### BACKGROUND

In today's business environment, flexible and responsive software applications are critical for enterprise competitiveness. Businesses invest significant resources in maintaining and updating their applications to respond to ever evolving business demands. In past most businesses used internal resources to perform these tasks. Within the past several years, businesses have increasingly turned to third-parties, both local and off-shore to maintain and update their application software. A number of factors have contributed to this shift in sourcing, including a desire to focus on core competencies, in-house resources that are not prepared to support major, or transformational changes, and labor rate differentials. The challenge many businesses face is deciding what sourcing alternatives are appropriate for their applications. This is complicated by the recognition that not one sourcing choice may be right across the board, for all of a business's applications. This calls for a sound and consistent way to assess sourcing alternatives for each application or group of applications.

### SUMMARY OF THE INVENTION

In general, in one aspect, the invention provides methods and apparatus, including computer program products, implementing techniques for grouping a plurality of application programs to form one or more application clusters. An assessment of alternative sourcing options is then considered for each of these application clusters, which includes performing a suitability assessment for each application cluster; performing a readiness assessment for each application cluster; and providing a sourcing model recommendation for each application cluster based at least upon the results of the suitability assessment and the readiness assessment.

Grouping applications can include techniques for identifying relationships between the plurality of applications and forming an application cluster based on the identified relationships.

Performing the suitability assessment can include techniques for calculating a suitability rating for each application cluster based on a plurality of suitability factors including at least one that is technical and one that is functional. The techniques can also include populating a suitability grid with one or more data points, each data point representing an application cluster and having a position corresponding to the suitability rating of the application cluster.

Performing the readiness assessment include techniques for calculating a readiness rating for each application cluster based on a plurality of readiness factors including at least one that is related to organization readiness, and one that is technical readiness. The techniques can also include populating a readiness grid with one or more data points, each data point representing an application cluster and having a position corresponding to the readiness rating of the application cluster.

The techniques can include performing a risk assessment of each application cluster, wherein performing comprises calculating a risk rating for each application cluster based on a plurality of risk factors including at least one of an application risk factor and a collaboration risk factor. The techniques can also include populating a risk grid with one or more data points, each data point representing an application cluster and having a position corresponding to the risk rating of the application cluster. The techniques for providing a sourcing model recommendation for each application cluster can be further based on the results of the risk assessment.

Advantages that can be seen in particular implementations of the invention include one or more of the following. Application clustering allows an enterprise to consider applications for their similarity of, for example support needs, data, interfaces and interactions. The alternative sourcing assessment approach also provides the fact- and analysis-based evidence needed to support sound management decisions for selecting among various sourcing alternatives.

The details of one or more implementations of the invention are set forth in the accompanying drawings and the description below. Further features, aspects, and advantages of the invention will become apparent from the description, the drawings, and the claims.

### BRIEF DESCRIPTION OF THE DRAWINGS

FIG. 1 shows a flowchart of a sourcing process.

FIG. 2 shows an assessment criteria rating scheme.

FIG. 3 shows a suitability grid.

FIG. 4 shows a readiness grid.

FIG. 5 shows a risk grid.

FIG. 6 is a block diagram of a computing system with a sourcing assessment program.

### DETAILED DESCRIPTION

An enterprise's application portfolio typically consists of hundreds of applications. An enterprise can be the portfolio owner or another responsible for maintaining, configuring, and/or controlling the application portfolio. Example enterprises may include a corporate or business entity, an individual, a governmental body, or another identifiable person and/or entity.

A successful information technology (IT) strategy demands an optimal utilization of an enterprise's current information systems while ensuring integration of the latest software applications and other IT assets in the enterprise's information and technology architecture. In the past, enterprises have turned to outsourcing largely to reduce costs. These days, enterprises often opt to outsource for more strategic reasons, such as getting up to speed in new markets, enhancing product and service capabilities, cutting investments in capital assets, staying abreast of leading-edge technologies, sharing risk, boosting margins and building partnerships. Although enterprises are increasingly recognizing the benefits for both vendors and enterprise users in adopting private-labeled externally hosted and outsourced applications, such outsourced applications raise issues of privacy, security and reliability. Thus, there remains a place in the enterprise IT strategy for software applications that are developed and/or managed in-house. It is therefore critical for an enterprise to develop a cohesive and strategic view of the role that its software applications play in delivering value to the enterprise and its customers, while focusing the enterprise's resources on what it does best and outsourcing to external experts those activities that are necessary but beyond its core competencies.

An enterprise can utilize a structured approach (also referred to as an “alternative sourcing assessment process”) to evaluate application sourcing options. This approach focuses on an analytic process that helps the enterprise recommend appropriate sourcing alternative selections. This technique enables breaking down a complete set of decisions into logical pieces. The approach also provides the fact- and analysis-based evidence needed to create a realistic work plan and to minimize implementation risk.

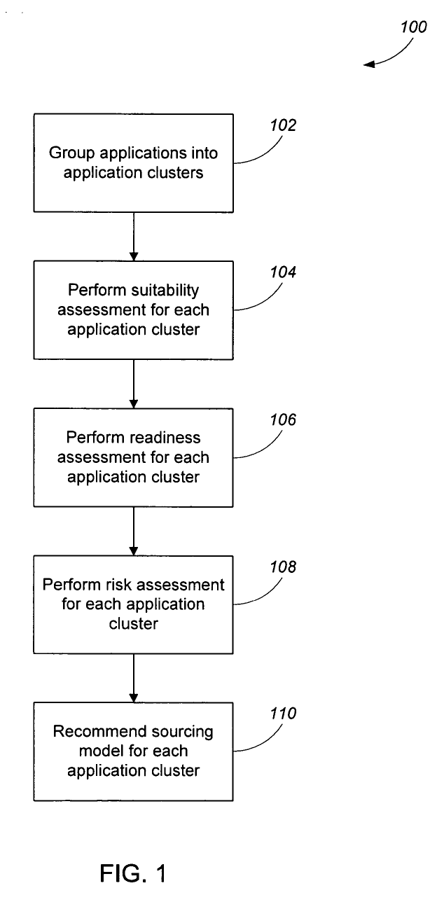

FIG. 1 shows an alternative sourcing process 100 implemented in a computer program, also referred to as “sourcing assessment program”, for assessing the appropriateness of various sourcing models with respect to an enterprise's strategic business objectives. The sourcing model recommendations identify an appropriate sourcing approach for the enterprise's applications, i.e., internally developed and alternatively-sourced applications.

Initially, the applications in the application portfolio are grouped into application clusters based upon a set of clustering factors (step 102). Once grouped, each application cluster is assessed in, e.g., three steps: (1) a suitability assessment is performed to determine whether the application cluster is suitable for alternative sourcing (step 104); (2) a readiness assessment is performed to determine the current state of the applications in the application cluster and the amount of effort that may be needed to prepare the applications to be moved into an alternative sourcing arrangement (step 106); and (3) a risk assessment is performed to determine a level of risk to the enterprise potentially involved in alternatively sourcing the applications in the application cluster (step 108). The results of the suitability assessment, readiness assessment, and risk assessment are analyzed, and sourcing model recommendations are made for each application cluster (step 110). Such recommendations can be to develop and/or maintain the application clusters in-house, on-shore, off-shore, or in variations/combinations thereof. In some implementations, the recommendations may include steps that may be taken to improve one or more of the ratings that result from the assessments, if the enterprise would like to encourage specific outcomes.

To prepare for the alternative sourcing assessment, information relating to the enterprise's application portfolio and business and IT strategies are first collected and provided to the sourcing assessment program. Typically, a preliminary interview session is conducted by a member of a consulting firm (e.g., Accenture®) with a member of the enterprise (e.g., the Chief Information Officer (CIO)) to identify the business objectives of the enterprise, and the related evaluation criteria to be employed during the alternative sourcing assessment process to obtain sourcing model recommendations that are aligned with the enterprise's business objectives. In some instances, each criterion can be assigned a weighting such that the relative importance of certain criteria can be factored into the alternative sourcing assessment process.

Another preliminary interview session may be conducted by a consulting firm member with a member of the enterprise's application development leadership (e.g., Head of Application Development) to acquire information about the specific applications in the application portfolio. The information acquired may, e.g., relate to the quality and completeness of the application code documentation, the architectural complexity of pieces of application code, the ease by which a test and/or development environment for a piece of application code can be replicated or accessed externally, to name a few.

In one scenario, as part of the preliminary interview process, the consulting firm member and the application development leadership can decide which applications in the application portfolio are to be grouped together to form application clusters. The clustering process is generally centered on answering the question: which applications are best kept together for function, technical, business process or strategic reasons? Applications can be clustered by the business group served or by common functionality. Application can be grouped by common underlying components, data stores or technical interdependencies. Alternatively, applications can be categorized by other factors, such as by common technical skills, development approaches and relationships to desired cross application projects. For strategic context, applications can also be clustered by their strategic value, such as by the new business capabilities and competitive advantages that the applications may enable or enhance. Other and/or fewer clustering factors can be used.

In another scenario, the sourcing assessment program can be implemented to provide a series of questions to the application development leadership and use the information acquired as input to an automated clustering process that groups the applications into application clusters without any further human intervention.

Once the application clusters are formed, the sourcing assessment program performs a suitability assessment, a readiness assessment, and a risk assessment for each application cluster to determine whether the application cluster is suitable, ready, and appropriate risk-wise for alternative sourcing. In one example, a user (e.g., a consulting firm member or an enterprise member) of the sourcing assessment program is provided with a set of questions through a graphical user interface. These questions are generally selected based on the evaluation criteria set forth in the initial steps. Each question is assigned a weighting based at least in part on the weighting assigned to the evaluation criterion from which the question is derived or is otherwise associated.

In one implementation, a first subset of the questions is designed to assess whether a given application cluster is suitable for alternative sourcing based on specific technical or functional criteria, although other criteria may be used. Two examples of technical suitability criteria questions are: (1) “On what platform does the application reside?”; and (2) “Is the interface architecture clearly structured?” Two examples of functional suitability criteria questions are: (1) “Is time-to-market a key driver?”; and (2) “Are the applications in this application cluster competitive differentiators?” Each response is first assigned a value depending on whether the technical or functional suitability criteria is positively fulfilled, partially fulfilled, or negatively fulfilled. For example, the values can be as follows: (1) yes=+1; (2) maybe=0; and (3) no=−1. The assigned value is then scaled based on the relative weighting of the question to derive a final value.

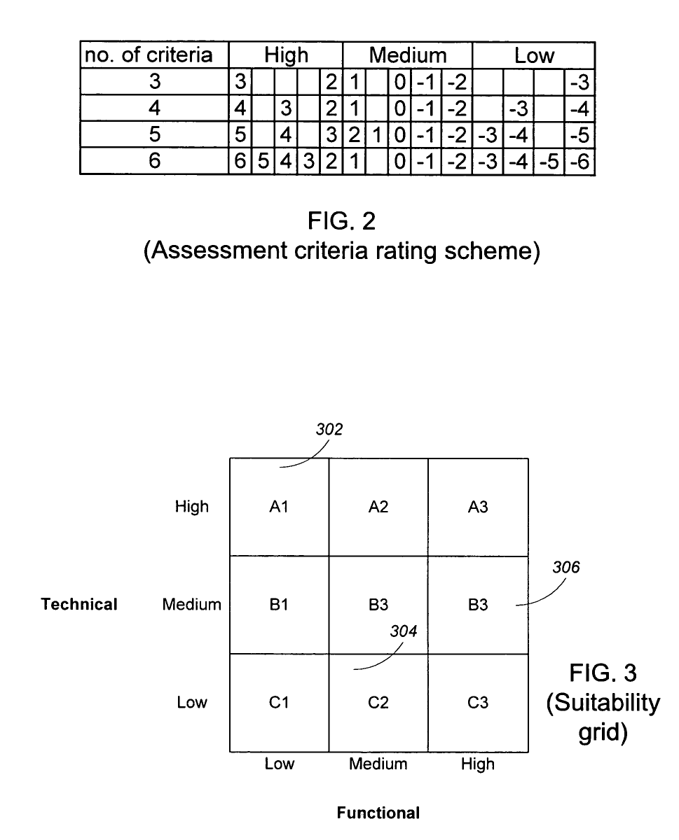

Based upon the user's response selection, the sourcing assessment program calculates suitability values for each application cluster by summing the final values based on criteria type. That is, the sourcing assessment program sums up the final values for the responses to the technical suitability criteria questions to calculate a technical suitability value, and sums up the final values for the responses to the functional suitability criteria questions to calculate a functional suitability value. Suppose, for example, that the user responded to three technical suitability criteria questions for an application cluster “X” with 2 “yes” answers and 1 “no” answer, and that each of the questions is equally weighted. The sourcing assessment program calculates the technical suitability value as (+1)+(+1)+(−1)=+1. The sourcing assessment program then performs a lookup operation of an assessment criteria rating scheme, an example of which is shown in FIG. 2, and assigns a technical suitability rating to the application cluster “X”. In this case, the lookup operation yields a “Medium” technical suitability rating. Similarly, if the user responded to five functional suitability criteria questions for the application cluster “X” with 3 “yes” answers and 2 “maybe” answers, the sourcing assessment program calculates the functional suitability value as (+1)+(+1)+(+1)+(0)+(0)=+3 and assigns the application cluster “X” a “High” functional suitability rating.

The sourcing assessment program then represents the suitability ratings on a suitability grid. FIG. 3 shows an example of a 3×3 suitability grid that has nine possible classifications (i.e., A1, A2, A3, B1, B2, B3, C1, C2, and C3). Each classification is defined by assigning one of three ratings (i.e., “Low”, “Medium” or “High”) to two properties (i.e., “Functional” and “Technical”). For example, the classification A1 302 is defined by a (“Low Functional”, “High Technical”) suitability rating, the classification C2 304 is defined by a (“Medium Functional”, “Low Technical”) suitability rating, the classification B3 306 is defined by a (“High Functional”, “Medium Technical”) suitability rating, and so on. The sourcing assessment program populates the suitability grid with data points. Each data point represents an application cluster and has a location that is defined by its calculated functional and technical suitability ratings. In the example above, the application cluster “X” is calculated to have a “High” functional suitability rating and a “Medium” technical suitability rating. Accordingly, the sourcing assessment program places a data point representing the application cluster “X” in the classification B3 306 defined by a (“High Functional”, “Medium Technical”) suitability rating.

A second subset of the questions is designed to assess whether a given application cluster is ready for alternative sourcing based on specific technical or organizational support criteria, although other criteria may be used. Three examples of technical readiness criteria questions are: (1) “Are the design and code documentation complete and of a good quality?”; (2) “Are the purpose and functionality of the applications well defined and clearly understood?”; and (3) “Is the test and/or development environment complex and can the environment be readily replicated or accessed externally?” Two examples of organizational support readiness criteria questions are: (1) “Does the application abide by established, standard development processes?”; and (2) “Are the dependencies upon key human resource few and can the roles played by the key human resources be transitioned easily?” Each response is first assigned a value depending on whether the technical or organizational readiness criteria is positively fulfilled, partially fulfilled, or negatively fulfilled. For example, the values can be as follows: (1) yes=+1; (2) maybe=0; and (3) no=−1. The assigned value is then scaled based on the relative weighting of the question to derive a final value.

Based upon the user's response selection, the sourcing assessment program calculates readiness values for each application cluster by summing the final values based on criteria type. That is, the sourcing assessment program sums up the final values for the responses to the technical readiness criteria questions to calculate a technical readiness value, and sums up the final values for the responses to the organizational readiness criteria questions to calculate an organizational readiness value. Suppose, for example, that the user responded to three technical readiness criteria questions for an application cluster “X” with 2 “yes” answers and 1 “no” answer, and that each of the questions is equally weighted. The sourcing assessment program calculates the technical readiness value as (+1)+(+1)+(−1)=+1. The sourcing assessment program then performs a lookup operation of an assessment criteria rating scheme, an example of which is shown in FIG. 2, and assigns a technical readiness rating to the application cluster “X”. In this case, the lookup operation yields a “Medium” technical readiness rating. Similarly, if the user responded to five organizational readiness criteria questions for the application cluster “X” with 3 “yes” answers and 2 “maybe” answers, the sourcing assessment program calculates the organizational readiness value as (+1)+(+1)+(+1)+(0)+(0)=+3 and assigns the application cluster “X” a “High” organizational readiness rating.

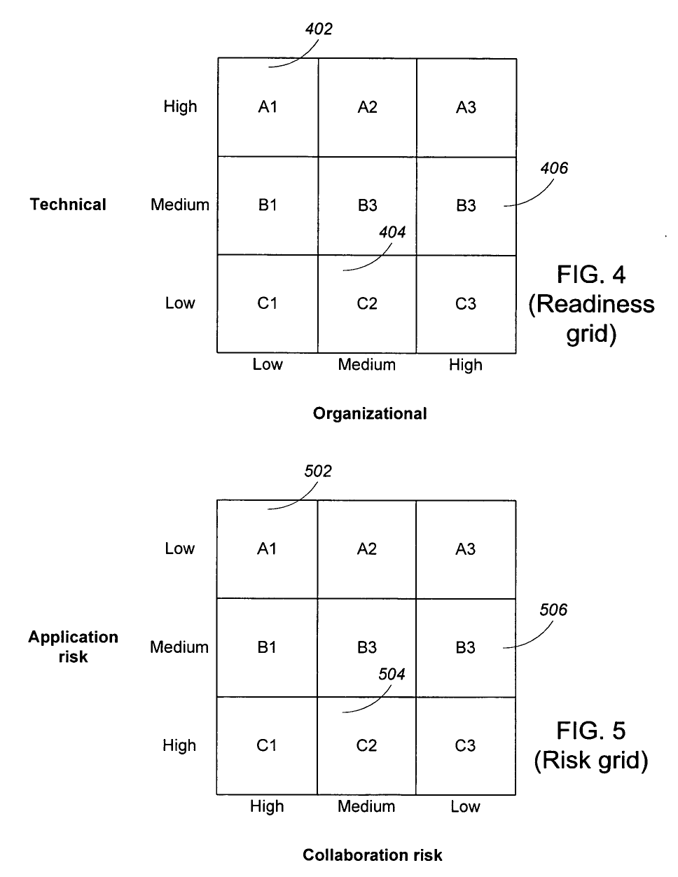

The sourcing assessment program then represents the readiness ratings on a readiness grid. FIG. 4 shows an example of a 3×3 readiness grid that has nine possible classifications (i.e., A1, A2, A3, B1, B2, B3, C1, C2, and C3). Each classification is defined by assigning one of three ratings (i.e., “Low”, “Medium” or “High”) to two properties (i.e., “Organizational” and “Technical”). For example, the classification A1 402 is defined by a (“Low Organizational”, “High Technical”) readiness rating, the classification C2 404 is defined by a (“Medium Organizational”, “Low Technical”) readiness rating, the classification B3 306 is defined by a (“High Organizational”, “Medium Technical”) readiness rating, and so on. The sourcing assessment program populates the readiness grid with data points. Each data point represents an application cluster and has a location that is defined by its calculated organizational and technical readiness ratings. In the example above, the application cluster “X” is calculated to have a “High” organizational readiness rating and a “Medium” technical readiness rating. Accordingly, the sourcing assessment program places a data point representing the application cluster “X” in the classification B3 406 defined by a (“High Organizational”, “Medium Technical”) readiness rating.

A third subset of the questions is designed to determine the risk inherent in alternatively sourcing each application cluster, both on-shore and off-shore. The risks associated with alternatively sourcing an application cluster may be categorized, e.g., as: (1) collaboration risks; and (2) application risks. Some examples of collaboration risk criteria relate to how impactful particular geo-political problems might be upon the enterprise's ability to rely on off-shore sourcing. Implications of factors such as the following would be considered: (1) “A country's political stability”; (2) “Civil conditions in the area of operations?”; (3) “Ease of travel and the obtaining of visas”; (4) “Effectiveness of Intellectual Property rights enforcement?”; and (5) “Workforce quality and capacity.” Some examples of application risk criteria may include enterprise disruptions risks based on: (1) quality and completeness of performance and acceptance plans; (2) quality and completeness of software development lifecycle methodologies”; (3) reputational impact of application failure; and (4) financial impact of application failure, or delays in the enterprise's ability to make changes at pace. Each response is assigned a value depending on whether the risk-related criteria is positively fulfilled, partially fulfilled, or negatively fulfilled. For example, the values can be as follows: (1) yes=+1; (2) maybe=0; and (3) no=−1. The assigned value is then scaled based on the relative weighting of the question to derive a final value.

Based upon the user's response selection, the sourcing assessment program calculates risk values for each application cluster by summing the assigned values based on criteria type. That is, the sourcing assessment program sums up the values for the responses to the collaboration risk criteria questions to calculate a collaboration risk value, and sums up the values for the responses to the application risk criteria questions to calculate an application risk value. Suppose, for example, that the user responded to six collaboration risk criteria questions for an application cluster “X” with 1 “yes” answer, 2 “maybe” answers and 3 “no” answers, and each of the questions is equally weighted. The sourcing assessment program calculates the collaboration risk value as (+1)+(0)+(−1)+(−1)+(0)+(−1)=−3. The sourcing assessment program then performs a lookup operation of the assessment criteria rating scheme of FIG. 2, and assigns a collaboration risk rating to the application cluster “X”. In this case, the lookup operation yields a “Low” collaboration risk rating. Similarly, if the user responded to four application risk criteria questions for the application cluster “X” with 1 “yes” answer, 1 “maybe” answer and 2 “no” answers, the sourcing assessment program calculates the application risk value as (+1)+(0)+(−1)+(−1)=−2 and assigns the application cluster “X” a “Medium” application risk rating.

The sourcing assessment program then represents the risk ratings on a risk grid. FIG. 5 shows an example of a 3×3 risk grid that has nine possible classifications (i.e., A1, A2, A3, B1, B2, B3, C1, C2, and C3). Each classification is defined by assigning one of three ratings (i.e., “Low”, “Medium” or “High”) to two properties (i.e., “Collaboration” and “Application”). For example, the classification B3 506 is defined by a (“Low Collaboration”, “Medium Application”) risk rating, the classification C2 504 is defined by a (“Medium Collaboration”, “High Application”) risk rating, the classification A1 502 is defined by a (“High Collaboration”, “Low Application”) risk rating, and so on. The sourcing assessment program populates the risk grid with data points. Each data point represents an application cluster and has a location that is defined by its calculated collaboration and application risk ratings. In the example above, the application cluster “X” is calculated to have a “Low” collaboration risk rating and a “Medium” application risk rating. Accordingly, the sourcing assessment program places a data point representing the application cluster “X” in the classification B3 506 defined by a (“Low Collaboration”, “Medium Application”) risk rating. The sourcing assessment program repeats the grid population process for each application cluster.

Once the suitability, readiness, and risk grids have been fully populated, the sourcing assessment program analyzes the results of the suitability assessment, readiness assessment, and the risk assessment. In one implementation, the sourcing assessment program employs a decision table as the method for determining a set of one or more sourcing model recommendations for each application cluster based on the combination of the suitability, readiness, and risk assessment ratings for the cluster. A decision-making member or, more typically a committee of the enterprise presented with the sets of sourcing model recommendations can then accept the sourcing assessment program's recommendations, with the guidance of a consulting firm member, a sourcing model for each application cluster.

In one example, the sourcing assessment program presents the sourcing model selections in the form of a report (e.g., electronic document or hardcopy print out) identifying the application clusters to be managed and/developed in-house, on-shore or off-shore. The sourcing assessment program can optionally generate reports that identify the cost of alternatively sourcing an application cluster and the projected savings to the enterprise of alternatively sourcing the application cluster.

In the examples described above, the alternative sourcing assessment approach is implemented using techniques that utilize grids and decision tables. Other tools may be used in order to perform the alternative sourcing assessment techniques.

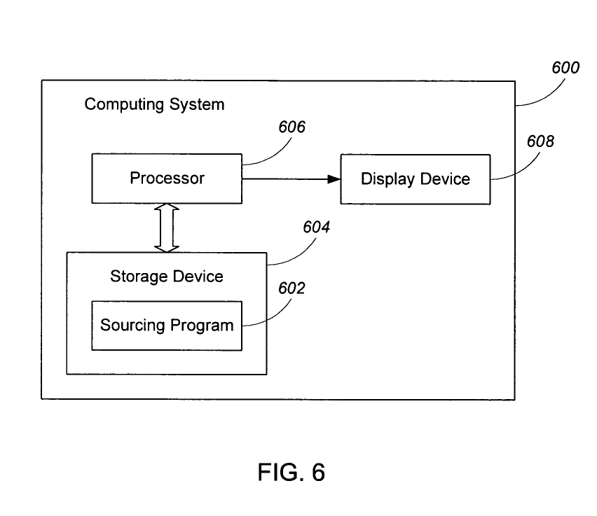

The invention and all of the functional operations described in this specification can be implemented in digital electronic circuitry, or in computer hardware, firmware, software, or in combinations of them. Referring to FIG. 6, the invention can be implemented as a computer program product, i.e., a sourcing assessment program 602 tangibly embodied in an information carrier, e.g., in a machine-readable storage device 604 or in a propagated signal, for execution by, or to control the operation of, data processing apparatus, e.g., a programmable processor 606, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer 600 or on multiple computers at one site or distributed across multiple sites and interconnected by a communication network.

Method steps of the invention can be performed by one or more programmable processors executing a computer program including the sourcing assessment program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a computer having a display device 606, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The invention has been described in terms of particular embodiments. Other embodiments are within the scope of the following claims. For example, the steps of the invention can be performed in a different order and still achieve desirable results.

What is claimed is:

1. A method comprising:
grouping a plurality of application programs to form one or more application clusters;
performing a suitability assessment for each application cluster;
performing a readiness assessment for each application cluster; and
providing a sourcing model recommendation for each application cluster based at least upon the results of the suitability assessment and the readiness assessment.

2. The method of claim 1, wherein grouping the applications comprises identifying relationships between the plurality of applications and forming an application cluster based on the identified relationships.

3. The method of claim 1, wherein performing the suitability assessment comprises:
calculating a suitability rating for each application cluster based on a plurality of suitability factors including at least one of a technical factor and a functional factor.

4. The method of claim 3, further comprising:
populating a suitability grid with one or more data points, each data point representing an application cluster and having a position corresponding to the suitability rating of the application cluster.

5. The method of claim 1, wherein performing the readiness assessment comprises:
calculating a readiness rating for each application cluster based on a plurality of readiness factors including at least one of an organization readiness factor and a technical readiness factor.

6. The method of claim 5, further comprising:
populating a readiness grid with one or more data points, each data point representing an application cluster and having a position corresponding to the readiness rating of the application cluster.

7. The method of claim 1, further comprising:
performing a risk assessment of each application cluster, wherein performing comprises calculating a risk rating for each application cluster based on a plurality of risk factors including at least one of an application risk factor and a collaboration risk factor.

8. The method of claim 7, further comprising:
populating a risk grid with one or more data points, each data point representing an application cluster and having a position corresponding to the risk rating of the application cluster.

9. The method of claim 7, wherein the sourcing model recommendation is further based on the results of the risk assessment.

10. A computer program product, tangibly embodied in an information carrier, comprising instructions to:
group a plurality of application programs to form one or more application clusters;
perform a suitability assessment of each application cluster;
perform a readiness assessment of each application cluster; and
provide a sourcing model recommendation for each application cluster based at least upon the results of the suitability assessment and the readiness assessment.

11. The computer program product of claim 10, wherein instructions to group the applications comprise instructions to identify relationships between the plurality of applications and forming an application cluster based on the identified relationships.

12. The computer program product of claim 10, wherein instructions to perform the suitability assessment comprise instructions to:
calculate a suitability rating for each application cluster based on a plurality of suitability factors including at least one of a technical factor and a functional factor.

13. The computer program product of claim 12, further comprising instructions to:
populate a suitability grid with one or more data points, each data point representing an application cluster and having a position corresponding to the suitability rating of the application cluster.

14. The computer program product of claim 10, wherein instructions to perform the readiness assessment comprise instructions to:
calculate a readiness rating for each application cluster based on a plurality of readiness factors including at least one of an organization readiness factor and a technical readiness factor.

15. The computer program product of claim 14, further comprising instructions to:
populate a readiness grid with one or more data points, each data point representing an application cluster and having a position corresponding to the readiness rating of the application cluster.

16. The computer program product of claim 10, further comprising instructions to:
perform a risk assessment of each application cluster, wherein performing a risk assessment comprises instructions to calculate a risk rating for each application cluster based on a plurality of risk factors including at least one of an application risk factor and a collaboration risk factor.

17. The computer program product of claim 16, further comprising instructions to:
populate a risk grid with one or more data points, each data point representing an application cluster and having a position corresponding to the risk rating of the application cluster.

18. The computer program product of claim 16, wherein the sourcing model recommendation is further based on the results of the risk assessment.

19. An apparatus comprising:
means for grouping a plurality of application programs to form one or more application clusters;
means for performing a suitability assessment of each application cluster;
means for performing a readiness assessment of each application cluster; and
means for providing a sourcing model recommendation for each application cluster based at least upon the results of the suitability assessment and the readiness assessment.

20. The apparatus of claim 19, further comprising:
means for performing a risk assessment of each application cluster, and wherein the means for providing a sourcing model recommendation for each application cluster is further based upon the results of the risk assessment.
